(19) United States
(12) Patent Application Publication
(10) Pub. No.: US 2014/0187253 A1
(43) Pub. Date: Jul. 3, 2014

(54) System and Method for Scheduling Feature Based on Power Status Reporting

(71) Applicants: Sachin Chhibber, Ashburn, VA (US); Dunmin Zheng, Vienna, VA (US)

(72) Inventors: Sachin Chhibber, Ashburn, VA (US); Dunmin Zheng, Vienna, VA (US)

(21) Appl. No.: 13/732,797

(22) Filed: Jan. 2, 2013

(51) Int. Cl. H04W 72/12

(52) U.S. Cl. CPC H04W 72/1205
USPC 455/452.1

(57) ABSTRACT

The present invention is drawn to a user equipment for use with a power source and a base station, wherein the power source can provide power. The user equipment includes a transmitting portion and a power source monitoring portion. The transmitting portion can transmit a signal to the base station. The power source monitoring portion can monitor a parameter of the power source and can generate a status signal based at least on the monitored parameter. The transmitting portion can additionally transmit the status signal for receipt by the base station.

### TECHNICAL HELD

Various embodiments described herein relate to radio frequency communications and, more particularly, to wireless communication networks and devices, and methods of operating the same.

### BACKGROUND

Wireless communication networks are increasingly being used for wireless communications with various types of wireless user equipment. The wireless network itself may include a plurality of wireless base stations, also commonly referred to as “base stations”, “radio access nodes”, “RAN nodes”, “NodeBs”, “eNodeBs” or simply as “nodes”, that define a plurality of cells, and a core network that controls the base stations and interfaces the base stations with other wired and/or wireless networks. The nodes may be terrestrial and/or space-based. The nodes communicate with wireless User Equipment (UE), also referred to as “user equipment”, “wireless terminals” or “mobile stations” or simply as “terminals”, using radio resources that are allocated to the wireless network. The radio resources may be defined in terms of time (for example, in a Time Division Multiple Access (TDMA) system), frequency (for example, in a Frequency Division Multiple Access (FDMA) system) and/or code (for example, in a Code Division Multiple Access (CDMA) system). The nodes may use licensed and/or unlicensed frequency spectrum. Radio resources may be assigned to UEs by the wireless network upon initial communication and may be reassigned due to, for example, movement of the UEs, changing bandwidth requirements, changing network traffic, etc.

Long term evolution, or LTE, is a standard for wireless communication of high-speed data for mobile phones and data terminals. The goal of LTE is to increase the capacity and speed of wireless data networks using digital signal processing techniques and modulation schemes that have recently been developed.

Many wireless systems, including LTE wireless systems, establish paired frequency bands to provide Frequency Division Duplex (FDD) links. The paired spectrum may include a downlink frequency band for transmission from a node to user equipment and an uplink frequency band that is spaced apart in frequency from the downlink frequency band, for transmission from the user equipment to the node, to thereby establish a frequency division duplex communications link between the node and the user equipment. A given user equipment may operate using a single carrier pair comprising a carrier from the uplink frequency band and a carrier from the downlink frequency band, and can be subsequently handed over to another carrier pair using another carrier from the uplink frequency band and the downlink frequency band. Alternatively, the user equipment may communicate using multiple carriers in multiple downlink frequency bands and multiple carriers in multiple paired uplink frequency bands in a communication technique commonly referred to as “carrier aggregation”.

The world's first LTE service was launched in Stockholm and Oslo in late 2009. LTE is the natural upgrade path for carriers with GSM/UMTS networks, and even CDMA providers are beginning a transition to LTE. For this reason LIE is anticipated to become the first truly global mobile phone standard.

In anticipation of the LTE standard growth, it is necessary to begin developing more efficient applications that are less taxing on the battery life of electronic devices. In current LTE standards, user equipment reports back various parameters back to a base station, and the base station uses that information to assign resources to each user equipment.

In many scenarios, particularly with multiple input/multiple output (MIMO) technology, these feedbacks are necessary and beneficial from a network capacity point of view but may not be optimal from a perspective of a user. For example, a scheduler may ask user equipment to transmit with a higher modulation scheme and transmit the lowest number of resource blocks. This may require a high power which may drain the user equipment battery and the users experience may suffer as a result.

What is needed is a scheduling system and method that more efficiently schedules channel usage within an LTE network.

### SUMMARY

The present invention provides a scheduling system and method that more efficiently schedules channel usage within an LTE network.

Various embodiments described herein can provide a user equipment of a wireless network for use with a power source and a base station. The user equipment may include a transmitting portion and a power source monitoring portion. The transmitting portion can transmit as signal to the base station. The power source monitoring portion can monitor a parameter of the power source and can generate a status signal based on at least on the monitored parameter. The transmitting portion can additionally transmit the status signal for receipt by the base station.

In embodiments described herein, the user equipment may further include a receiving portion that can receive a transmission scheme from the base station. Moreover, the transmission scheme may be based at least on the status signal.

In some embodiments, when the status signal indicates the monitored parameter is above a predetermined threshold, the transmission scheme is a first transmission scheme, and when the status signal indicates the monitored parameter is equal to or below the predetermined threshold, the transmission scheme is a second transmission scheme. In these embodiments, the transmitting portion can transmit the signal in a first manner when the transmission scheme is the first transmission scheme, and can transmit the signal in a second manner when the transmission scheme is a second transmission scheme.

In further embodiments, the first transmission scheme would expend a first amount of power to transmit the signal, and the second transmission scheme would expend a second amount of power to transmit the signal, wherein the second amount of power is less than the first amount of power.

In yet further embodiments, the transmission scheme is additionally based on at least one of the group consisting of channel status, modulation data rate, and network capacity.

In embodiments described herein, the user equipment may further includes an override portion that can generate an override signal. The transmitting portion can further transmit an override request, based on at least on the override signal, for receipt by the base station. In some embodiments, the transmission scheme is additionally based at least on the override request.

In some embodiments, the transmitting portion may transmit the status signal for receipt by the base station in at least one of the group of situations consisting of at predetermined instances, at predetermined periods, in response to a status signal request from the base station and combinations thereof.

Various embodiments described herein can provide a base station of a wireless network for use with a user equipment and power source. The base station may include a receiving portion and a transmission scheme determining portion. The receiving portion can receive a status signal from the user equipment, wherein the status signal is based at least on the parameter of the power source. The transmission scheme determining portion can determine, based at least on the status signal, a transmission scheme for use by the user equipment and can transmit the transmission scheme for receipt by the user equipment.

In other embodiments, the receiving portion can additionally receive a signal from the user equipment. When the status signal indicates the parameter of the power source is above a predetermined threshold, the transmission scheme is a first transmission scheme, and when the status signal indicates the parameter of the power source is equal to or below the predetermined threshold, the transmission scheme is a second transmission scheme. In these embodiments, the receiving portion can receive the signal in a first manner when the transmission scheme is the first transmission scheme, and can receive the signal in a second manner when the transmission scheme is the second transmission scheme.

In further embodiments, the receiving portion can receive an override signal from the user equipment and the transmission scheme determining portion can determine the transmission scheme of the user equipment additionally based at least on the override request.

Various embodiments described above have focused on a user equipment and base station of a wireless network. However, analogous methods of operating a user equipment of a wireless network and operating a base station of a wireless network may be provided, according to various embodiments described herein.

For example, a user equipment may have an associated method of operation with a power source and base station. The method may include monitoring, via a power source monitoring portion, a parameter of the power source, generating, via the power source monitoring portion, a status signal based at least on the monitored parameter, transmitting, via a transmitting portion, the status signal for receipt by the base station, and transmitting, via the transmitting portion, a signal to the base station. Various analogous embodiments of operating a user equipment may be provided, as was described above.

Similarly, a base station may have an associated method of operation with a power source and user equipment. The method may include receiving, via a receiving portion, a status signal from the user equipment, the status signal being based at least on a parameter of the power source, determining, via a transmission scheme determining portion and based on at least on the status signal, a transmission scheme for use by the user equipment, generating via the transmission scheme determining portion, the transmission scheme, and transmitting, via the transmission scheme determining portion, the transmission scheme to the user equipment. Analogous methods for base station may also be provided according to any of the embodiments described above.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a block diagram for a prior art user equipment/base station system; and

FIG. 2 illustrates a block diagram for a user equipment/base station system in accordance with aspects of the present invention.

### DETAILED DESCRIPTION

Various embodiments described herein may arise from a recognition that a base station of a cellular network assigning different transmission schemes to individual user equipment. For example, a base station may assign a transmission scheme to a user that maximizes the data transmission rate, based in part on a parameter of the power source of the user equipment of the user. In this example, data packets are transmitted at the fastest transmission rate available. This transmission scheme may use a lot of power to transmit data which will quickly drain the power source of the user equipment, which would be detrimental to the experience of the user.

A problem with the prior art, however, is that status signals and transmission schemes are chosen based on only data transfer rates, channel status, or network capacity. None of these parameters currently take into account the battery life of electronic devices. As a result, it is currently not possible to optimize transmission schemes based on conserving battery life of user equipment.

In sharp contrast, various embodiments described herein allow a user equipment to monitor a parameter of its power source and generate a parameter signal based on that parameter. A status signal, based on the parameter signal, is then transmitted to the base station. Once arriving at the base station, the status signal may be used by a transmission scheme determining portion to determine the optimal transmission scheme.

If the status signal indicates that the power source of a user equipment is sufficiently charged, a transmission scheme may be chosen that has a high transmission rate as well is high power use. On the other hand, if the status signal indicates that the power source of the user equipment is insufficiently charged, a transmission scheme may be chosen that has a lower transmission rate as well as lower power use in order maximize the remaining life of the power source.

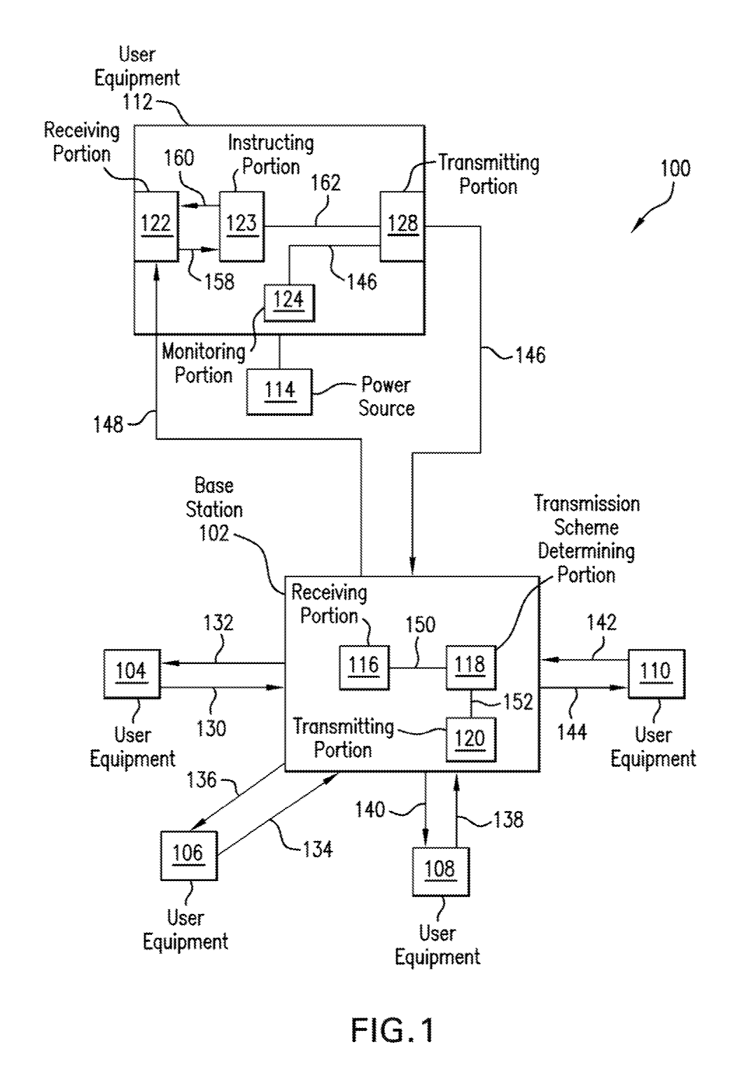

FIG. 1 illustrates a prior art user equipment/base station system 1100.

As illustrated in the figure, system 100 includes a base station 102, a user equipment 104, a user equipment 106, a user equipment 108, a user equipment 110 and a user equipment 112.

Base station 102 further includes a receiving portion 116, a transmission scheme determining portion 118, and a transmitting portion 120. In this example, each of receiving portion 116, transmission scheme determining portion 118 and transmitting portion 120 are distinct elements. However, in some embodiments, at least two of receiving portion 116, transmission scheme determining portion 118 and transmitting portion 120 may be combined as a unitary element. Further, in some embodiments, at least one of receiving portion 116, transmission scheme determining portion 118 and transmitting portion 120 may be implemented as a computer having stored therein tangible, non-transitory, computer-readable media for carrying or having computer-executable instructions or data structures stored thereon. Such tangible, non-transitory, computer-readable media can be any available media that can be accessed by a general purpose or special purpose computer.

Each of user equipment 104, 106, 108, 110 and 112 includes operations elements therein. For purposes of brevity, the elements of user equipment 112 will be further described. In this example, user equipment 112 further includes power source 114, a receiving portion 122, a monitoring portion 124 and a transmitting portion 128. In this example, each of receiving portion 122, monitoring portion 124 and transmitting portion 128 are distinct elements. However, in some embodiments, at least two of receiving portion 122, monitoring portion 124 and transmitting portion 128 may be combined as a unitary element. Further, in some embodiments, at least one of receiving portion 122, monitoring portion 124 and transmitting portion 128 may be implemented as a computer having stored therein tangible, non-transitory, computer-readable media for carrying or having computer-executable instructions or data structures stored thereon. Such tangible, non-transitory, computer-readable media can be any available media that can be accessed by a general purpose or special purpose computer.

Base station 102 is arranged to send and receive data from user equipment 104, user equipment 106, user equipment 108, user equipment 110 and user equipment 112.

User equipment 104 is arranged to send a status signal 130 to base station 102 and to receive a signal 132 from base station 102. User equipment 106 is arranged to send a status signal 134 to base station 102 and to receive a signal 136 from base station 102. User equipment 108 is arranged to send a status signal 138 to base station 102 and to receive a signal 140 from base station 102. User equipment 110 is arranged to send a status signal 142 to base station 102 and to receive a signal 144 from base station 102. User equipment 112 is arranged to send a status signal 146 to base station 102 and to receive a signal 148 from base station 102.

Power source 114 is arranged to provide power to user equipment 112.

With respect to base station 102, receiving portion 116 is operable to receive status signal 130 from user equipment 104, status signal 134 from user equipment 106, status signal 138 from user equipment 108, status signal 142 from user equipment 110 and status signal 146 from user equipment 112. Receiving portion 116 is additionally operable to send each status signal to transmission scheme determining portion 118 via signal 150.

Transmission scheme determining portion 118 is operable to determine a transmission scheme for each of user equipment 104, user equipment 106, user equipment 108, user equipment 110, and user equipment 112 based on their respective status signals. Transmission scheme determining portion 118 is additionally operable to instruct transmission portion 120, via an instruct signal 152, to transmit a different transmission scheme to each of user equipment 104, user equipment 106, user equipment 108, user equipment 110, and user equipment 112.

Transmitting portion 120 is operable to transmit a different transmission scheme, based on instruct signal 152, to user equipment 104 via signal 132, to user equipment 106 via signal 136, to user equipment 108 via signal 140, to user equipment 110 via signal 144, and to user equipment 112 via signal 148.

With respect to user equipment 112, receiving portion 122 is operable to receive a transmission scheme from base station 102.

Monitoring portion 124 is operable to monitor a parameter of user equipment 112. Non-limiting examples of a parameter include channel status, modulation data rate, and network capacity. Monitoring portion 124 is further operable to generate status signal 146 based on the monitored parameter and send status signal 146 to transmitting portion 128.

Transmitting portion 128 is operable to transmit to base station 102 in plurality of transmission schemes.

In operation, at the start of system 100, base station 102 is receiving/transmitting data to user equipment 104, user equipment 106, user equipment 108, and user equipment 110 in a first transmission scheme. At some time later, a user will want to use user equipment 112. To start, the user turns on power source 114 to provide power to user equipment 112.

Once user equipment 112 has started, monitoring portion 124 will generate an initial status signal based on predetermined, monitored, parameters. These predetermined monitored parameters may include data transfer rate, bandwidth, network capacity and combinations thereof. In this example embodiment, the status signal that is generated is based on the data transfer rate.

Once an initial status signal has been generated, monitoring portion 124 then sends status signal 146 to transmitting portion 128. Transmitting portion 128 then sends status signal 146 to receiving portion 116 of base station 102. Receiving portion 116 receives status signal 146 and sends it to transmission scheme determining portion 118.

After receiving status signal 146, transmission scheme determining portion 118 will rank user equipment 114, based on status signal 146, amongst user equipment 104, user equipment 106, user equipment 108, and user equipment 110. Once ranked, transmission scheme determining portion 118 will choose the optimal transmission schemes for each user equipment based on resource availability and data transfer rate.

In this example embodiment, suppose that user equipment 104, user equipment 106, user equipment 108, and user equipment 110 are all transmitting at the fastest data transfer rate possible and that user equipment 112 is transferring at the slowest data transfer rate possible. In this example, transmission scheme determining portion 118 would assign user equipment 112 a faster transmission scheme in order to raise it in the ranking. Transmission scheme determining portion 118 would assign user equipment 104, user equipment 106, user equipment 108, and user equipment 110 a slower data transfer rate in order to lower them in the ranking. This method optimizes the data transfer rate evenly among all user equipment that is communicating with base station 102.

Once transmission scheme determining portion 118 determines that user equipment 112 needs to be assigned a faster transmission scheme, it will send instructions via instruct signal 152, to transmitting portion 120. Transmitting portion 120 will send the instructions to receiving portion 122 via signal 148, and receiving portion 122 will then send the instructions to instructing portion 123 via signal 158.

After receiving instructions, instructing portion 123 will instruct receiving portion 122, via signal 160, and transmitting portion 128, via signal 162, to begin transmitting and receiving in a different transmission scheme.

In contrast with the prior art system discussed above, in accordance with embodiments of the present invention, a monitoring portion is operable to monitor a power parameter of a user equipment.

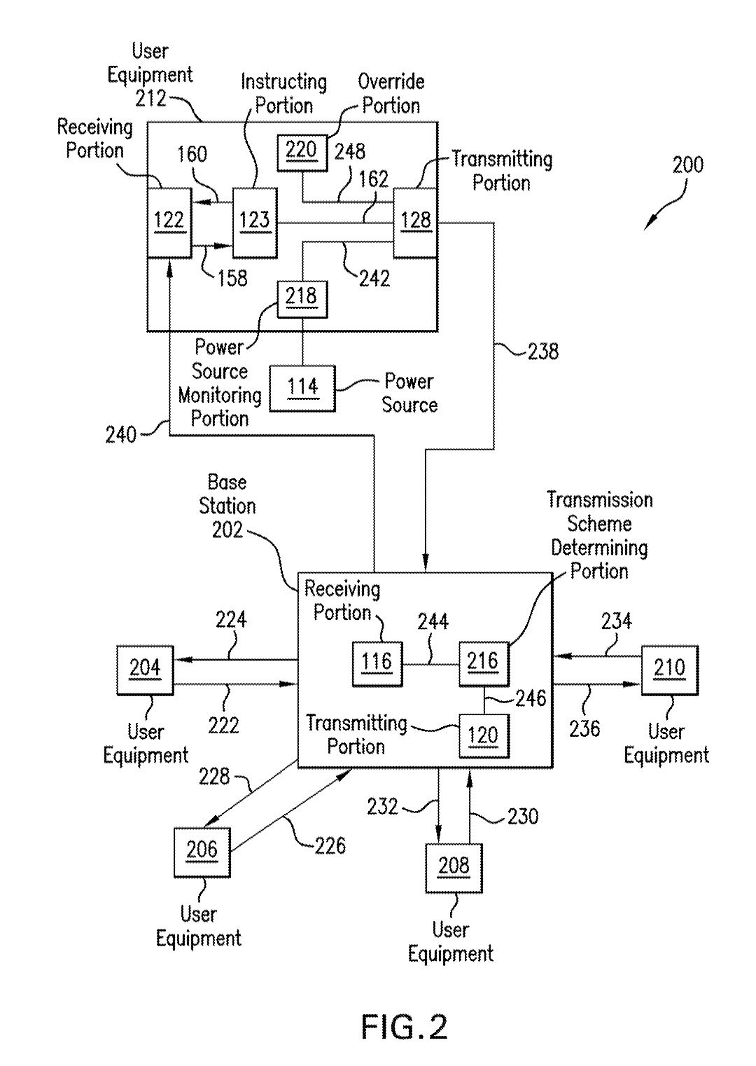

FIG. 2 illustrates an example user equipment/base station system 200 in accordance with aspects of the present invention.

As illustrated in the figure, system 200 includes a base station 202, a user equipment 204, a user equipment 206, a user equipment 208, a user equipment 210 a user equipment 212.

Base station 202 further includes receiving portion 116, a transmission scheme determining portion 216, and transmitting portion 120. In this example, each of receiving portion 116, transmission scheme determining portion 216 and transmitting portion 120 are distinct elements. However, in some embodiments, at least two of receiving portion 116, transmission scheme determining portion 216 and transmitting portion 120 may be combined as a unitary element. Further, in some embodiments, at least one of receiving portion 116, transmission scheme determining portion 216 and transmitting portion 120 may be implemented as a computer having stored therein tangible, non-transitory, computer-readable media for carrying or having computer-executable instructions or data structures stored thereon. Such tangible, non-transitory, computer-readable media can be any available media that can be accessed by a general purpose or special purpose computer.

Each of user equipment 204, 206, 208, 210 and 212 includes operations elements therein. For purposes of brevity, the elements of user equipment 212 will be further described. In this example, user equipment 212 further includes power source 114, receiving portion 122, a power source monitoring portion 218, an override portion 220 and transmitting portion 128. In this example, each of receiving portion 122, power source monitoring portion 218, override portion 220 and transmitting portion 128 are distinct elements. However, in some embodiments, at least two of receiving portion 122, power source monitoring portion 218, override portion 220 and transmitting portion 128 may be combined as a unitary element. Further, in some embodiments, at least one of receiving portion 122, power source monitoring portion 218, override portion 220 and transmitting portion 128 may be implemented as a computer having stored therein tangible, non-transitory, computer-readable media for caring or having computer-executable instructions or data structures stored thereon. Such tangible, non-transitory, computer-readable media can be any available media that can be accessed by a general purpose or special purpose computer.

Base station 202 is arranged to send and receive data to and from user equipment 204, user equipment 206, user equipment 208, user equipment 210 and user equipment 212.

User equipment 204 is arranged to send a status signal 222 to base station 202 and to receive a signal 224 from base station 202. User equipment 206 is arranged to send a status signal 226 to his station 202 and to receive a signal 228 from base station 202. User equipment 208 is arranged to send a status signal 230 to base station 202 and to receive a signal 232 from base station 202. User equipment 210 is arranged to send a status signal 234 to base station 202 and to receive a signal 236 from base station 202. User equipment 212 is arranged to send a status signal 238 to base station 202 and to receive a signal 240 from base station 202.

Power source 114 is arranged to provide power to user equipment 212.

With respect to base station 202, receiving portion 116 is operable to receive status signal 222 from user equipment 204, status signal 226 from user equipment 206, status signal 230 from user equipment 208, status signal 234 from user equipment 210 and status signal 242 from user equipment 212. Receiving portion 116 is additionally operable to send each status signal to transmission scheme determining portion 216 via signal 244.

Transmission scheme determining portion 216 is operable to determine a transmission scheme for each of user equipment 204, user equipment 206, user equipment 208, user equipment 210, and user equipment 212 based on their respective status signals. Transmission scheme determining portion 216 is additionally operable to instruct transmission portion 120, via an instruct signal 246, to transmit a different transmission scheme to each of user equipment 204, user equipment 206, user equipment 208, user equipment 210, and user equipment 212.

Transmitting portion 120 is operable to transmit a different transmission scheme, based on instruct signal 246, to user equipment 204 via signal 224, to user equipment 206 via signal 228, to user equipment 208 via signal 232, to user equipment 210 via signal 236, and to user equipment 212 via signal 240.

With respect to user equipment 212, receiving portion 122 is operable to receive a transmission scheme from base station 202.

Power source monitoring portion 218 is operable to monitor a parameter of power source 114, non-limiting examples of such parameters include amount of remaining power, rate of power use, and percentage of remaining power and combinations thereof. For purposes of discussion herein, the monitored parameter of power source 114 is the amount of remaining power.

Further, the method of monitoring a parameter of power source 114 may include threshold monitoring, instance monitoring and combinations thereof. Threshold monitoring may include establishing predetermined thresholds and determining when the monitored parameter reaches such thresholds. Instance monitoring may include monitoring the parameter at predetermined instances, non-limiting examples of which include upon start-up, during cell-to-cell hand-offs, or established time frames. For purposes of discussion herein, the method of monitoring a parameter of power source 114 is threshold monitoring.

In some embodiments, power source monitoring portion 218 is additionally operable to monitor additional parameters of user equipment 212, non-limiting examples of which include channel status, modulation data rate, and network capacity.

Power source monitoring portion 218 is further operable to generate a parameter signal 242 based on the monitored parameter and send parameter signal 242 to transmitting portion 128. For purposes of discussion herein, parameter signal 242 is based on the amount of remaining power in power source 114. In an example embodiment, parameter signal 242 is generated when the amount of remaining power in power source 114 is below a predetermined threshold.

Override portion 220 is operable to transmit an override signal 248 to transmission portion 128. There may be instances when the user of user equipment 212 does not want information related to the status of power source 114 to affect the usage of network services provided by base station 202. In such instances, override portion 220 will override parameter signal 242 by way of override signal 248.

Transmitting portion 128 is operable to transmit data to base station 102 in plurality of transmission schemes. Transmit portion 128 is additionally able to transmit status signal 238 for receipt by the base station.

In example embodiments, status signal 238 is based on parameter signal 242 and override signal 248. Since parameter signal 242 is based on a parameter of power source 114, then in theses example embodiments, status signal 238 is additionally based on the parameter of power source 114 and override signal 248. Still further, in some embodiments, status signal 238 is additionally based on other parameters as discussed above with reference to FIG. 1, non-limiting examples of which include channel status, modulation data rate, network capacity and combinations thereof.

In some embodiments, transmitting portion 128 may transmit status signal 238 for receipt by base station 202 at predetermined instances or predetermined periods, a non-limiting example of which includes upon receipt of parameter signal 242. As such, transmitting portion 128 may transmit status signal 238 in a manner coincident with threshold monitoring, instance monitoring and combinations thereof by power source monitoring portion 218.

In some embodiments, transmitting portion 128 may transmit status signal 238 for receipt by base station 202 in response to a status signal request from base station 202. For example, base station 202 may send status signal requests to user equipment 212 at predetermined instances. These status signal requests may prompt power source monitoring portion 114 to monitor the parameter of power source 114 and generate parameter signal 242. Accordingly, transmitting portion 128 would transmit status signal 238 as a result of the status signal request from base station 202.

In some embodiments, transmitting portion 128 may transmit status signal 238 for receipt by base station 202 based on a combination of predetermined instances or predetermined periods and response to a status signal request from base station 202.

As illustrated in FIG. 2, user equipment/base station system 200 is somewhat similar to user equipment/base station system 100 of FIG. 1. However, monitoring portion 124 of user equipment 112 has been replaced by power source monitoring portion 218 of user equipment 212. Further, transmission scheme determining portion 118 of base station 102 has been replaced by transmission scheme determining portion 216. Finally, user equipment 212 additionally includes override portion 220.

In an example embodiment, when parameter signal 242 indicates the monitored parameter is above a predetermined threshold, user equipment 212 will be instructed by base station 202 to transmit data in a first transmission scheme that expends a first amount of power. Further, when parameter signal 242 indicates the monitored parameter is at or below the predetermined threshold, user equipment 212 will be instructed by base station 202 to transmit data in a second transmission scheme that expends a second amount of power, wherein the second amount of power is less than the first amount of power. For example, if the power remaining in power source 114 is above a threshold, e.g. 15%, then base station 202 will permit user equipment 212 to transmit in a first transmission scheme that consumes a large amount of network resources. Alternatively, if the power remaining in power source 114 is below the 15%, then base station 202 will instruct user equipment 212 to transmit in a second transmission scheme that consumes a smaller amount of network resources.

Clearly, the above example is not limiting. Example embodiments may include a wide range of thresholds and transmission schemes. The single threshold associated with two transmission schemes is provided merely for purposes of explanation.

With respect to base station 202, transmission scheme determining portion 216 is similar to transmission scheme determining portion 118 of base station 102, as discussed above with reference to FIG. 1. Transmission scheme determining portion 216 is operable to determine a transmission scheme for use by the user equipment and operable to transmit the transmission scheme for receipt by the user equipment. However, transmission scheme determining portion 216 is operable to determine the transmission scheme based at least on status signal 238, which is based at least on a parameter of power source 114. Transmission scheme determining portion 216 is further operable to determine the transmission scheme of the user equipment additionally based at least on override request 244.

In one example method of operation, the start of system 200 is similar to that of system 100. Base station 202 is receiving/transmitting data to user equipment 204, user equipment 206, user equipment 208, and user equipment 210 in a first transmission scheme. At some time later, a user will want to use user equipment 212. The user will turn on power source 114 to provide power to user equipment 212.

Once user equipment 212 has started, power source monitoring portion 218 will generate an initial parameter signal based on a parameter of power source 114. In this example embodiment, in accordance with aspects of the present invention, power source monitoring portion 218 monitors the charge left in power source 114.

Power source monitoring portion 218 generates parameter signal 242 based on the charge left in power source 114. Power source monitoring portion 202 then sends parameter signal 242 to transmitting portion 128. Transmitting portion 128 then sends status signal 238 to receiving portion 116 of base station 202. Receiving portion 116 receives status signal 238 and sends it to transmission scheme determining portion 216.

After receiving status signal 238, transmission scheme determining portion 216 will determine what transmission scheme user equipment 212 should use, based on network resources. Transmission scheme determining portion 216 will choose the optimal transmission schemes for each user equipment, in this example embodiment, based at least on remaining battery life.

In an example embodiment, suppose that user equipment 204, user equipment 206, user equipment 208, and user equipment 210 all have fully charged batteries and user equipment 212 only has 14% battery life left. In this example, transmission scheme determining portion 216 would assign user equipment 212 a transmission scheme that minimizes power usage to conserve battery life and would assign user equipment 204, user equipment 206, user equipment 208, and user equipment 210 a transmission scheme that requires more power because they each have a fully charged battery.

As mentioned above, in some embodiments, transmission scheme determining portion 216 may periodically or otherwise query each of user equipment 204, user equipment 206, user equipment 208, user equipment 210 and user equipment 212 with a status signal request. Once queried, each user equipment will transmit a respective status signal, based on its respective battery life, back to transmission scheme determining portion 216. Transmission scheme determining, portion 216 will again rank each user equipment according to their battery life and leave or reassign a transmission scheme to each user equipment based on their ranking.

In another example embodiment, the user of user equipment 212 may be able to pay a fee or otherwise subscribe to a service that gives them priority over other users. In this case, override signal 248 may override parameter signal 242. Thus, status signal 238 will be modified to reflect override signal 248. This modified status signal 238 will make its way to transmission scheme determining portion 216 via transmitting portion 128. Based on this modified status signal 238, transmission scheme determining portion 216 will assign user equipment 212 a transmission scheme that conserves battery life despite where it ranks amongst all other user equipment.

In other words, in the example embodiment with an override signal, if a user's power level is sufficiently low so as to otherwise trigger a low power transmission scheme, and thus a low data rate transmission scheme, the user may opt to override the low power transmission scheme trigger. In this manner, the user may continue to use the higher power transmission scheme, thus using the higher data rate transmission scheme. Of course the user may decide not to override the low power transmission scheme trigger in order to extend battery life.

Various embodiments were described herein with reference to the accompanying drawings, in which embodiments of the invention are shown. This invention may, however, be embodied in many different forms and should not be construed, as limited to the embodiments set forth herein; rather, these embodiments are provided so that this disclosure will be thorough and complete, and will fully convey the scope of the invention to those skilled in the art.

It will be understood that, when an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Furthermore, “coupled”, “connected”, “responsive”, or variants thereof as used herein may include wirelessly coupled, connected, or responsive. Like numbers refer to like elements throughout. The terminology used herein is for the purpose of describing particular embodiments only and is not intended to be limiting of the invention. As used herein, the singular forms “a”, “an” and “the” are intended to include the plural forms as well, unless the context clearly indicates otherwise. Well-known functions or constructions may not be described in detail for brevity and/or clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. Moreover, as used herein, the term “and/or” includes any and all combinations el one or mote of the associated listed items.

Unless otherwise defined, all terms (including technical and scientific terms) used herein have the same meaning as commonly understood by one of ordinary skill in the an to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Various embodiments described herein can operate in any of the following Radio Access Technologies: Advanced Mobile Phone Service (AMPS), ANSI-136, Global Standard for Mobile (GSM) communication, (General Packet Radio Service (GPRS), enhanced data rates for GSM evolution (EDGE), DCS, PDC, PCS, code division multiple access (CDMA), wideband-CDMA, CDMA2000, Universal Mobile Telecommunications System (UMTS), 3GPP LTE (3^{rd} Generation Partnership Project Long Term Evolution) and/or 3GPP LTE-A (LTE Advanced). For example, GSM operation can include reception/transmission in frequency ranges of about 824 MHz to about 849 MHz and about 869 MHz to about 894 MHz. EGSM operation can include reception/transmission in frequency ranges of about 880 MHz to about 914 MHz and about 925 MHz to about 960 MHz. DCS operation can include transmission/reception in frequency ranges of about 1410 MHz to about 1785 MHz and about 1805 MHz to about 1880 MHz. PDC operation can include transmission in frequency ranges of about 893 MHz to about 953 MHz and about 810 MHz to about 885 MHz. PCS operation can include transmission/reception in frequency ranges of about 1850 MHz to about 1910 MHz and about 1930 MHz to about 1990 MHz. 3GPP LTE operation can include transmission/reception in frequency ranges of about 1920 MHz to about 1980 MHz and about 2110 MHz to about 2170 MHz. Other Radio Access Technologies and/or frequency bands can also be used in various embodiments described herein. All these systems are designed to operate in a variety of bands typically known as the international Mobile Telecommunications (IMT) bands that are defined by the International Telecommunications Union Radio Communication Bureau (ITU-R) and can, in general, be located in frequency ranges between 200 MHz and 5 GHZ within the current state of the art. It should, however, be noted that various embodiments described herein are equally applicable for any radio system, and are not restricted in any way to the IMT hands in any way.

For purposes of illustration and explanation only, various embodiments of the present invention were described herein in the context of user equipment that are configured to carry out cellular communications (e.g., cellular voice and/or data communications). It will be understood, however, that the present invention is not limited to such embodiments and may be embodied generally in any wireless communication terminal that is configured to transmit and receive according to one or more radio access technologies.

As used herein, the term “user equipment” includes cellular and/or satellite radiotelephone(s) with or without a display (text/graphical); Personal Communications System (PCS) terminal(s) that may combine a radiotelephone with data processing, facsimile and/or data communications capabilities; Personal Digital Assistant(s) (PDA) or smart phone(s) that can include a radio frequency transceiver and a pager, Internet/Intranet access, Web browser, organizer, calendar and/or a global positioning system (GPS) receiver; and/or conventional laptop (notebook) and/or palmtop (netbook) computer(s) or other appliance(s), which include a radio frequency transceiver. As used herein, the term “user equipment” also includes any other radiating user device that may have time-varying or fixed geographic coordinates and/or may be portable, transportable, installed in a vehicle (aeronautical, maritime, or land-based) and/or situated and/or configured to operate locally and/or in a distributed fashion over one or more terrestrial and/or extra-terrestrial location(s). The term “base station” includes any fixed, portable and/or transportable device that is configured to communicate with one or more user equipment and a core network, and includes, for example, terrestrial cellular base stations (including microcell, picocell, wireless access point and/or ad hoc communications access points) and satellites, that may be located terrestrially and/or that have a trajectory above the earth at any altitude.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, if used herein, the common abbreviation “e.g.”, which derives from the Latin phrase exempli gratia, may be used to introduce or specify a general example or examples of a previously mentioned item, and is not intended to be limiting of such item. If used herein, the common abbreviation “i.e.”, which derives from the Latin phrase id est, may be used to specify a particular item from a more general recitation.

Exemplary embodiments were described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by processor circuitry. These computer program instructions may be provided to processor circuitry of a general purpose computer circuit, special purpose computer circuit such as a digital processor, and/or other programmable data processor circuit to produce a machine, such that the instructions, which execute via the processor circuitry of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). These computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access Memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “processor circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of as given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show at primary direction of communication, it is to be understood that communication may occur in the opposite direction to the depicted arrows.

Many different embodiments were disclosed herein, in connection with the following description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the invention and, although specific terms are employed, they are used in a generic, and descriptive sense only and not for purposes of limitation, the scope of the invention being set forth in the following claims.

What is claimed as new and desired to be protected by Letters Patent of the United States is:

1. A user equipment fur use with a power source and a base station, the power source being operable to provide power, said user equipment comprising:
a transmitting portion operable to transmit a signal to the base station; and
a power source monitoring portion operable to monitor a parameter of the power source and to generate a parameter signal based at least on the monitored parameter,
wherein said transmitting portion is additionally operable to transmit a status signal, based on the parameter for receipt by the base stations.

2. The user equipment of claim 1, further comprising:
a receiving portion operable to receive a transmission scheme from the base station,
wherein the transmission scheme is based at least on the status signal.

3. The user equipment of claim 2,
wherein when the status signal indicates the monitored parameter is above a predetermined threshold, the transmission scheme is a first transmission scheme,
wherein when the status signal indicates the monitored parameter is equal to or below the predetermined threshold, the transmission scheme is a second transmission scheme,
wherein said transmitting portion is operable to transmit the signal in a first manner when the transmission scheme is the first transmission scheme,
wherein said transmitting portion is operable to transmit the signal in a second manner when the transmission scheme is the second transmission scheme.

4. The user equipment of claim 3,
wherein the first transmission scheme would expend a first amount of power to transit the signal,
wherein the second transmission scheme would expend a second amount of power to transmit the signal, and
wherein the second amount of power is less than the first amount of power.

5. The user equipment of claim 2, wherein the transmission scheme is additionally based on at least one of the group consisting of channel status, modulation data rate and network capacity.

6. The user equipment of claim 1, further comprising:
an override portion operable to generate an override signal,
wherein said transmitting portion is further operable to transmit an override request, based at least on the override signal, for receipt by the base station, and
wherein the transmission scheme is additionally based at least on the override request.

7. The user equipment of claim 1, wherein said transmitting portion is operable to transmit the status signal for receipt by the base station in at least one of the group of situations consisting of at predetermined instances, at predetermined periods, in response to a status signal request from the base station and combinations thereof.

8. A method of using user equipment with a power source and a base station, the power source being operable to provide power, said method comprising:
monitoring, via a power source monitoring portion, a parameter of the power source;
generating, via the power source monitoring portion, a parameter signal based at least on the monitored parameter;
transmitting, via a transmitting portion, a status signal based on the parameter signal for receipt by the base station; and
transmitting via the transmitting portion, a signal to the base station.

9. The method of claim 8, further comprising:
receiving, via a receiving portion, a transmission scheme from the base station,
wherein the transmission scheme is based at least on the status signal.

10. The method of claim 9,
wherein when the status signal indicates the monitored parameter is above a predetermined threshold, the transmission scheme is a first transmission scheme,
wherein when the status signal indicates the monitored parameter is equal to or below the predetermined threshold, the transmission scheme is a second transmission scheme,
wherein said transmitting, via a transmitting portion, a signal to the base station comprises transmitting, via the transmitting portion, the signal in a first manner when the transmission scheme is the first transmission scheme,
wherein said transmitting, via a transmitting portion, a signal to the base station comprises transmitting, via the transmitting portion, the signal in a second manner when the transmission scheme is the second transmission scheme.

11. The method of claim 10,
wherein the first transmission scheme would expend a first amount of power to transmit the signal,
wherein the second transmission scheme would expend a second amount of power to transmit the signal, and
wherein the second amount of power is less than the first amount of power.

12. The method of claim 9, wherein the transmission scheme is additionally based on at least one of the group consisting of channel status, modulation data rate and network capacity.

13. The method of claim 8, further comprising:
generating, via an override portion, an override signal; and
transmitting, via the transmitting portion, an override request, based at least on the override signal, for receipt by the base station,
wherein the transmission scheme is additionally based at least on the override request.

14. The method of claim 3, transmitting, via a transmitting portion, the status signal for receipt by the base station comprises transmitting the status signal for receipt by the base station in at least one of the group of situations consisting of at predetermined instances, at predetermined periods, in response to a status signal request from the base station and combinations thereof.

15. A base station for use with a user equipment having a power source, the power source being operable to provide power to the user equipment, said base station comprising:
a receiving portion operable to receive a status signal from the user equipment, the status signal being based at least on a parameter of the power source; and
a transmission scheme determining portion operable to determine, based at least on the status signal, a transmission scheme for use by the user equipment and operable to transmit the transmission scheme for receipt by the user equipment.

16. The base station of claim 15,
wherein said receiving portion is additionally operable to receive a signal from the user equipment,
wherein when the status signal indicates the parameter of the power source is above a predetermined threshold, the transmission scheme is a first transmission scheme,
wherein when the status signal indicates the parameter of the power source is equal to or below the predetermined threshold, the transmission scheme is a second transmission scheme,
wherein said receiving portion is operable to receive the signal in a first manner when the transmission scheme is the first transmission scheme, and
wherein said receiving portion is operable to receive the signal in a second manner when the transmission scheme is the second transmission scheme.

17. The base station of claim 6,
wherein said receiving portion is further operable to receive an override signal from the user equipment, and
wherein said transmission scheme determining portion is operable to determine the transmission scheme of the user equipment additionally based at least on the override request.

18. A method of using a base station with a user equipment having a power source, the power source being operable to provide power to the user equipment, said method comprising:
receiving, via a receiving portion, a status signal from the user equipment, the status signal being based at least on a parameter of the power source;
determining, via a transmission scheme determining portion and based on at least on the status signal, a transmission scheme for use by the user equipment;
generating, via the transmission scheme determining portion, the transmission scheme; and
transmitting, via the transmission scheme determining portion, the transmission scheme to the user equipment.

19. The method of claim 18, further comprising:
receiving, via the receiving portion, a signal from the user equipment,
wherein when said determining, via a transmission scheme determining portion, a transmission scheme of the user equipment based at least on the status signal comprises determining that the parameter of the power source is above a predetermined threshold, said generating, via the transmission scheme determining portion, a transmission scheme based at least on the determined transmission scheme comprises generating, via the transmission scheme determining portion, the transmission scheme as a first transmission scheme,
wherein when said determining, via a transmission scheme determining portion, a transmission scheme of the user equipment based at least on the status signal comprises determining that the parameter of the power source is equal to or below the predetermined threshold, said generating, via the transmission scheme determining portion, a transmission scheme based at least on the determined transmission scheme comprises generating, via the transmission scheme determining portion, the transmission scheme as a second transmission scheme,
wherein said receiving, via the receiving portion, a signal from the user equipment comprises receiving the signal in a first manner when the transmission scheme is the first transmission scheme, and
wherein said receiving, via the receiving portion, a signal from the user equipment comprises receiving the signal in a second manner when the transmission scheme is the second transmission scheme.

20. The method of claim 19, further comprising:
receiving, via the receiving portion, an override signal from the user equipment,
wherein said determining, via a transmission scheme determining portion, a transmission scheme of the user equipment based at least on the status signal comprises determining the transmission scheme of the user equipment additionally based at least on the override request.
